(19) United States
(12) Patent Application Publication
(10) Pub. No.: US 2025/0217527 A1
(43) Pub. Date: Jul. 3, 2025

(54) Method of Constructing an Installation of Solar Carports and Process and Platform For Use in Executing the Method

(71) Applicant: SolarPorts Development, Mill Valley, CA (US)

(72) Inventors: Joseph Stolp Sherer, IV, Mill Valley, CA (US); Paul Gray Sherer, Palo Alto, CA (US)

(21) Appl. No.: 18/399,432

(22) Filed: Dec. 28, 2023

(51) Int. Cl. G06F 30/13; B60L 53/31; B60L 53/51; E04H 6/42; H02S 20/20

(52) U.S. Cl. CPC G06F 30/13; B60L 53/31; B60L 53/51; E04H 6/42; H02S 20/20

(57) ABSTRACT

A method is provided for use in constructing solar power-generating installation of a plurality of solar carports at a real property site. An overhead digital image of the real property site is acquired and a geographic region within the real property site is identified as installation sites for the solar carports. A design layout of one or more models of a solar carport is created and includes overlaying representations of the model(s) of solar carports on the geographic region. Then, construction specifications for solar carports in the design layout is created. Also, a set of construction plans in conformance with the design layout is automatically generated. A construction method and machine for implementing the method are also provided.

### BACKGROUND

The present technology pertains to carports provided with solar panels, and to methods and systems for furnishing real property sites with solar power. The present technology also pertains to electric vehicle (EV) charging and, in particular, to solar-powered EV charging.

Societal pressure for reducing our use and reliance on fossil fuels continues to increase from an environmental perspective of reducing greenhouse gas emission and air pollution, and because of challenges in securing a reliably cost-efficient supply of fossil fuels. In response, demands for renewable energy and renewable-based energy technologies have been growing. Chief among these technologies is solar-based energy technologies and, in particular, photovoltaic (PV) modules (commonly referred to as solar panels) which convert solar energy to electricity. Electricity generated using solar-based technologies is not only environmentally friendly but is cost efficient especially compared to the price per kWh (the energy delivered by one kilowatt of power for one hour) that public utilities charge.

Moreover, many governmental authorities are seeking and even requiring reductions in fossil fuel use, including in transportation sectors. For example, the state of California is banning all gasoline-powered cars after 2035. Accordingly, one of the chief technologies that has sky-rocketed over the past decade are electric vehicles (EVs) which have electric motors powered by rechargeable batteries instead of internal combustion engines, and hybrid vehicles also known as plug-in hybrid electric vehicles (PHEVs) which have both electric motors and internal combustion engines which are selectively operated while driving. For instance, EV sales grew worldwide from 2012-2017 from 100,000 to 1 million units per year, but in 2023 over 1 million EVs were sold in the month of July alone.

Although EVs reduce the use of fossil fuels and the environmental impact of fossil-fuel use, they nonetheless create a demand for electricity needed to charge their batteries. In addition, a lack of infrastructure for providing the electricity necessary and adapted for use in charging batteries of EVs is one of the major hurdles for alternative fuel vehicles that use batteries.

Therefore, the growing demand for and use of EVs is accompanied by a growing demand for both public infrastructure and renewable energy to power them.

One emerging technology that can satisfy either or both of these demands is the solar carport. A solar carport is a multi-purpose structure that combines the protective function of a traditional carport with the electricity generation capabilities of solar panels. Like a regular carport, a solar carport has a roof. However, instead of the typical solid roof, a solar carport utilizes solar panels as roofing material. These panels capture sunlight and convert it into electricity.

The electricity can be used to easily supply power to any building or device on the grounds on which the solar carport is installed. Moreover, if a solar carport is equipped with an electric vehicle charger (EVC) powered by the electricity generated by the solar panels, an EV parked in the solar carport can be charged while sheltered from the sun, rain and other elements. Thus, the benefits of a solar carport are the dual advantage of protecting cars from the elements and generating clean energy simultaneously. This can potentially offset electricity costs and contribute to sustainability.

However, the scaling of solar carports to offer these and other advantages at various sites where many cars can park presents many obstacles. These obstacles include design costs of sending engineers or technicians out to survey the sites, and engineering costs of custom building the solar carports to meet customer demands or preferences while overcoming site limitations.

### SUMMARY

According to one aspect of the present technology, there is provided a construction method comprising acquiring a digital image of an overhead view of a real property site, identifying a geographic region within the boundary of the real property site as installation sites for a plurality of solar carports, creating a design layout of one or more models of solar carports, automatically generating a set of construction plans based on construction specifications corresponding to the solar carports represented in the design layout, and constructing a solar power-generating installation, conforming to the design layout, on the geographic region of the real property site using the set of construction plans. Each respective model of the solar carport includes a support structure of one or more generally upright supports, a roof structure mounted to and supported by the one or more supports, and solar panels mounted to the roof structure. The design layout is created at least in part by displaying the digital image and overlaying respective representations of the solar carports on portions of the digital image depicting the geographic region. The solar power-generating installation is constructed by building a plurality of the respective solar carports within the geographic region as each operatively connected to respective ones of the solar panels.

According to a similar aspect of the present technology, there is provided a method for use in constructing a solar power-generating installation at a real property site, comprising acquiring a digital image of an overhead view of a real property site, identifying a geographic region within the boundary of the real property site as installation sites for a plurality of solar carports, creating a design layout of one or more models of solar carports, and automatically generating a set of construction plans for a solar power-generating installation tailored to the real property site, including by automatically generating a set of construction plans based on construction specifications of the solar carports represented in the design layout. Each model of solar carport includes a support structure of one or more generally upright supports, a roof structure mounted to and supported by the support structure, and solar panels mounted to the roof structure. The design layout is created by displaying the digital image, and overlaying respective representations of the solar carports on portions of the digital image depicting the geographic region.

According to still another aspect of the present technology, there is provided a machine comprising a processor and a non-transitory computer readable medium storing instructions executable by the processor to acquire a digital image of an overhead view of a real property site, display the digital image, provide a tool by which representations of one or more models of solar carports can be overlayed on the digital image, create a design layout of solar carports each of a respective one of the models, and create a set of construction plans for a solar power-generating installation tailored to the real property site. Each model of solar carport includes one or more supports, a roof structure mounted to and supported by the one or more supports, and solar panels mounted to the roof structure. The design layout is created from respective representations of the solar carports overlayed on portions of the digital image. The construction plans are tailored to the real property site, and are produced by automatically generating a set of construction plans based on at least those construction specifications of the solar carports represented in the design layout.

Accordingly, the construction plans for the installation of solar carports can be tailored to the real property site without sending personnel out to the real property site, thereby saving on construction costs. Furthermore, the construction specifications and associated construction plans can be created rapidly using a web-based platform. Therefore, construction costs can also be minimized because it is unnecessary to custom design and custom build solar carports for the site from the ground up. As a result, the construction cost savings can be passed onto the entity commissioning the installation, in addition to that entity receiving the benefit of the energy costs saved by generating solar power at the site instead of procuring a corresponding amount of electricity from the local utility company. Furthermore, and not the least importantly, the solar power-generating installation increases the value of the site.

According to yet another aspect of the present technology, one or more electric vehicle chargers (EVCs) can be provided as each associated with and connected to the solar panels of one of the solar carports. Here too, the specifications of the EVCs, including of different types (Level 2, Level 3, for example), can be created dynamically or be storied in a digital repository so that the construction plans may also include instructions for their installation, etc. In this case, the solar power-generating installation can serve as a source of revenue if EV owners are charged to purchase electricity at one or more of the EVCs of the solar power-generating installation. Not only that, but the presence of EVCs can attract owners of EVs to the site which may be of added benefit when, for example, the site offers commercial services.

### BRIEF DESCRIPTION OF THE DRAWINGS

These and other aspects, features and advantages of the present technology will become clearer from the detailed description of embodiments and examples thereof that follows, with reference to the accompanying drawings of which:

FIG. 1 is a flow chart of a method for use in creating a solar-powered electric vehicle (EV) charging installation tailored to a real property site;

FIG. 2 is an example of an overhead image of the real property site acquired by carrying out the method of FIG. 1;

FIG. 3 is a diagram illustrating a geographical region selected within the boundary of the real property site, for the solar-powered EV charging installation, in an example of carrying out the method of FIG. 1;

FIG. 4 is a perspective view of an example of a solar carport which can be constructed as part of a solar-powered EV charging installation by implementing the present technology;

FIGS. 5A, 5B and 5C are side elevation views of three models of solar carports which can be selected to construct a solar-powered EV charging installation by implementing the present technology, and illustrate a sample of construction specifications of the solar carports;

FIG. 6 is a screen shot of a design layout of a solar power-generating installation created in the example of carrying out the method of FIG. 1;

FIGS. 7, 8 and 9 are each a screen shot of an example of a step for producing the design layout shown in FIG. 6;

FIGS. 10A-10D are tables, respectively, of another set of sample design specifications of a solar carport;

FIGS. 10E and 10F are each a diagram of part of a work schedule that may constitute construction plans automatically generated in an example of carrying out the method of FIG. 1;

FIG. 11 is a schematic block diagram of a computing device for a machine in the exemplary electronic form of a computer system, within which a set of instructions for causing the machine to perform the steps and/or methods shown and described with reference to FIGS. 1-10 can be executed, according to the present technology; and

FIG. 12 is a schematic diagram of a machine in the exemplary electronic form of a computer system in network, and by which the methods shown and described with reference to FIGS. 1-10 can be executed, according to the present technology.

### DETAILED DESCRIPTION

The present technology and examples thereof will now be described more fully in detail hereinafter with reference to the accompanying drawings. In the drawings, elements may be shown schematically for ease of understanding. Also, like numerals and like reference characters are used to designate like elements throughout the drawings.

Certain examples may be described and illustrated in terms of blocks which carry out a described function or functions. These blocks, which may be referred to herein as computer modules, tools or the like, are physically implemented by analog and/or digital circuits such as logic gates, integrated circuits, microprocessors, microcontrollers, memory circuits, passive electronic components, active electronic components, optical components, hardwired circuits and the like, and may be driven by firmware and/or software of non-transitory computer readable media (CRM). In the present disclosure, the term non-transitory computer readable medium (CRM) refers to any medium that stores data in a machine-readable format for short periods or in the presence of power such as a memory device or Random Access Memory (RAM). The circuits may, for example, be embodied in one or more semiconductor chips, or on substrate supports such as printed circuit boards and the like. The circuits constituting a block may be implemented by dedicated hardware or by a specialized computer (e.g., one or more programmed microprocessors and associated circuitry, a CPU and associated memory programmed with and/or storing algorithms, operating instructions, audio signals/information, text, etc.), or by a combination of dedicated hardware to perform some functions of the block and a specialized computer to perform other functions of the block. Each block of the examples may be physically separated into two or more interacting and discrete blocks and conversely, the blocks of the examples may be physically combined into more complex blocks while still providing the essential functions of the present technology.

In addition, the terminology used herein for the purpose of describing particular embodiments of the present technology is to be taken in context. For example, the term “comprises” or “comprising” when used in this disclosure indicates the presence of stated features in a system or steps in a process but does not preclude the presence of additional features or steps. Also, throughout the disclosure and for ease of description, the term “car” will be understood as referring to basically any standard automotive passenger vehicle or truck, and the term electric vehicle (EV) will be understood as applying to any vehicle powered by electricity, i.e., including plug-in hybrid electric vehicles (PHEVs). Still further, although the term “battery” is used throughout this description, it will be understood that the same description applies to known battery alternatives for storing energy which can be delivered in the form of electricity. Moreover, the terms solar panel and photovoltaic module (PVM) are used interchangeably. Finally, in respect of terminology, the term “dynamically” will be understood to mean automatically through the execution of algorithms and the like by a computer.

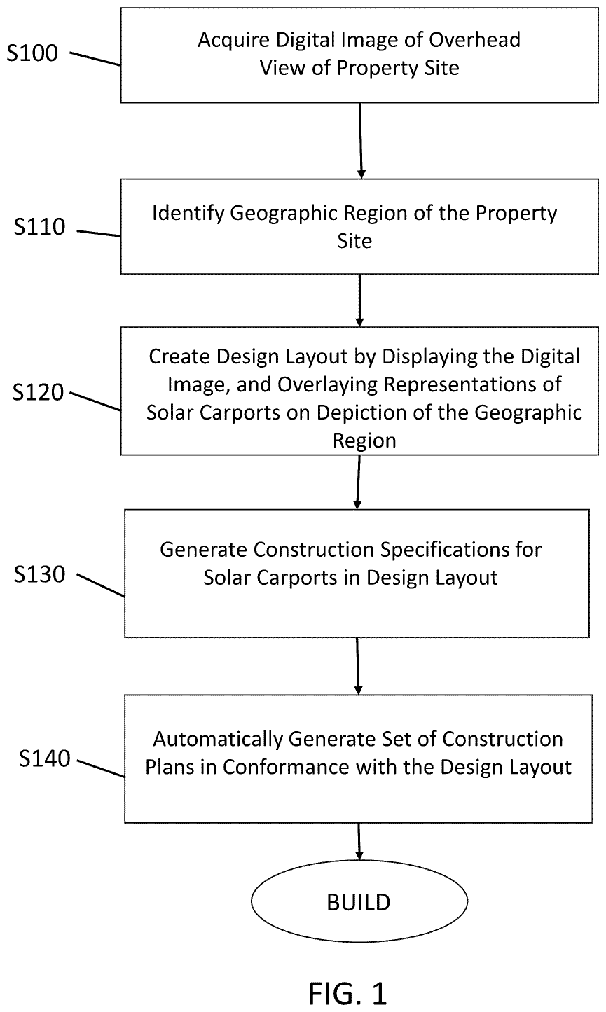

A method for use in constructing a solar power-generating installation of a plurality of solar carports at a real property site, according to the present technology, will now be described with reference to FIG. 1. Examples of the solar carports will be described in more detail later on. Such real property sites include but are not limited to sites having retail, office or government buildings and a parking lot or garage. In these examples, the installation will be constructed in a parking lot or on an exposed top level of a parking garage, i.e., at an area of the site where the sun is accessible.

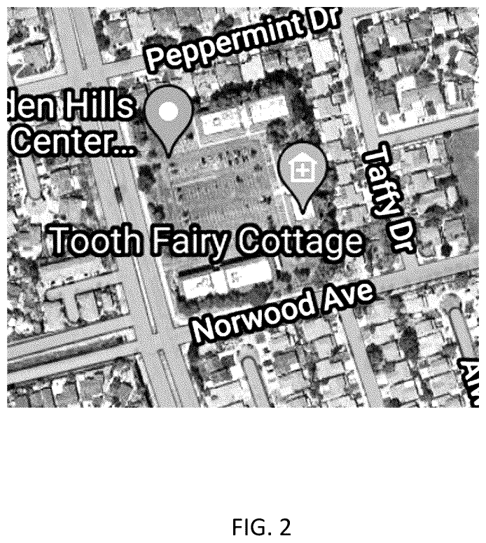

Referring now to FIG. 1, the method begins by acquiring a digital image of an overhead view of the property site (S100). In one example of this step, a database of satellite images of existing real property is accessed, and one of the satellite images based on the street address of the real property site is acquired. FIG. 2 shows an example of such a satellite image. If necessary, the image can be enlarged. For example, a vicinity map may be obtained by accessing a free service like Google Maps on a computer through the web, and typing in the site address. The satellite image view may then be called up and enlarged using the tools provided by Google Maps, and the resulting image may be used in real time, captured and/or the resulting URL can be recorded for recalling the image for later use. Alternatively, an overhead image of the site may be taken by a drone having a camera, and downloaded to a computer.

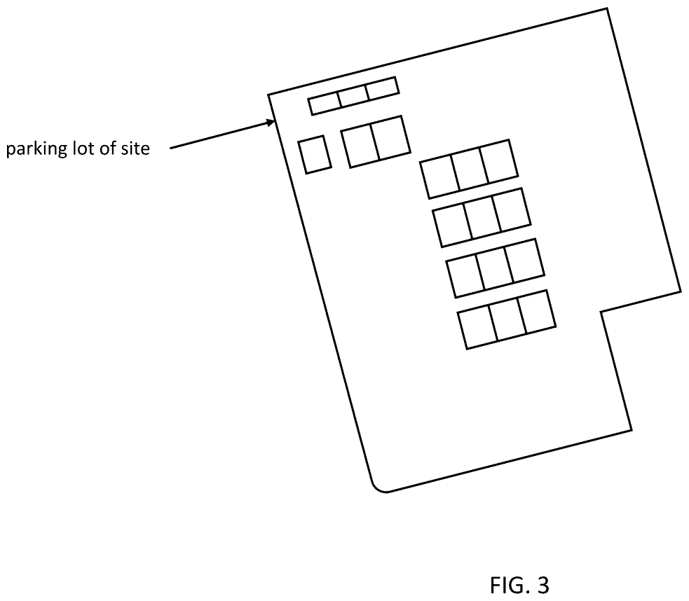

Next, a geographic region within the boundary of the real property site is identified and selected as the portion of the site where the solar power-generating installation will be installed (S110). For example, an area within the real property site dedicated for use as vehicle parking is identified, and all, some part or parts of the area is/are selected as the geographic region. Therefore, the geographic region may be one contiguous region or more than one region separated from each other. FIG. 3 shows an example in which the geographic region selected consists of seven discrete regions within a parking lot. Further, in this respect, typically the geographic region will be the part or parts of the real property site selected by the entity commissioning the solar power-generating installation, in consultation with the designer and/or builder of the installation. Considerations that may factor into the selection include directions that the roofs of the solar carports will face relative to the sun as dictated by the parking spaces to be covered, location relative to sidewalks, the nature of the land directly adjacent the parking area, center islands, surrounding trees, etc., and estimated amounts of cost savings that may be realized by generating solar power using solar carports within the select region.

Once the desired geographic region for the solar-powered EV charging installation is selected, a design layout of solar carports is created (S120) with each of the solar carports represented in the design layout being one or more models having similar components. The design layout may be created by displaying the digital image of the real property site (FIG. 3) and overlaying respective representations of models of the solar carports on portions of the digital image depicting the geographic region.

Furthermore, locations of one or more electric vehicle chargers (EVCs) within the selected geographic region as each associated with a respective one of the solar carports may be indicated on the design layout.

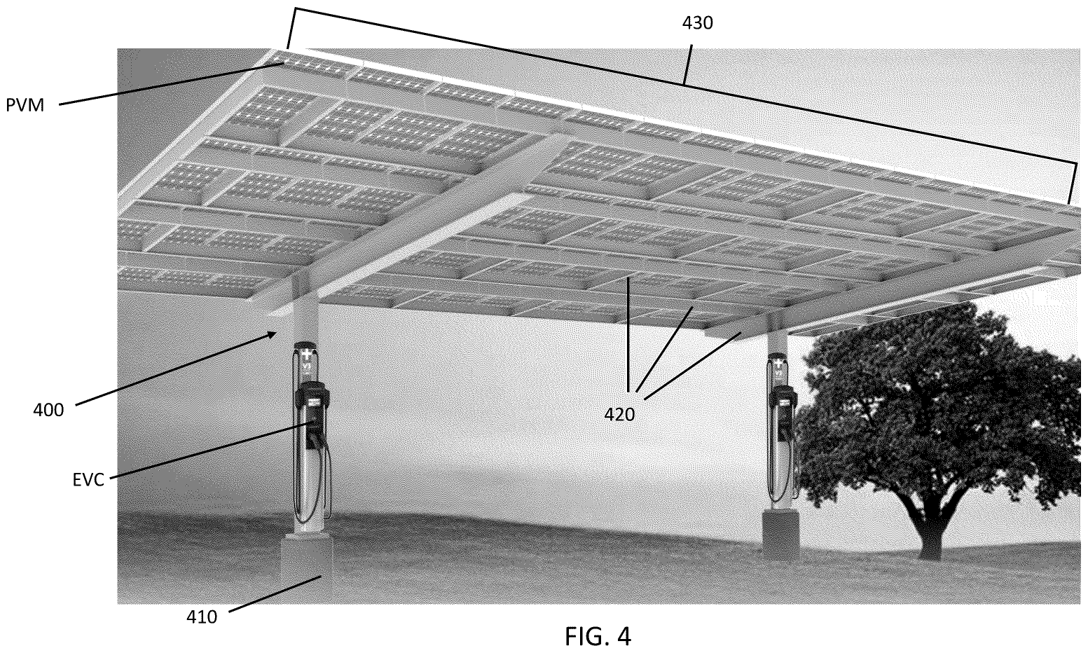

Reference will now be made to FIG. 4 showing an example of one model of a solar carport 400 which may be built in numbers to construct a solar power-generating installation according to the present technology.

In this example, the solar carport 400 includes a substantially upright support structure of two supports 410 (which may be shown referred to as “columns”), a roof structure 420 mounted to and supported by the supports, and a group of solar panels 430 mounted to the roof structure 420 to form a roof of the solar carport 400. Each of the solar panels 430 comprises a photovoltaic module (PVM) for converting sunlight into electricity. An inverter (not shown) to which the array 430 is electrically connected may be mounted to the support structure.

In this example as mentioned above, two supports 410 are shown but in another example, the support structure may comprise one or more than two supports. Each support 410 may comprise a concrete footing formed using a sonotube, and a column fixed to and rising from the footing. Also, in this example, the roof is supported by the supports 410 at locations adjacent one edge thereof. However, the roof may be supported at other locations relative to the supports, i.e., more towards or at the middle of the roof, depending on various design factors such as the load exerted on the supports 410 by the roof and suitability for a particular type of location at the site, which will be described in more detail later on.

Also shown are electric vehicle chargers (EVCs) powered by solar energy produced by the array of solar panels 430. In this example, two EVCs are provided with each mounted to one of the supports 410. Alternatively, the EVCs may be provided separately on their own dedicated supports beneath the roof of the solar carport 400, such that electric vehicles (EVs) parked under the solar carport still have access to the EVCs.

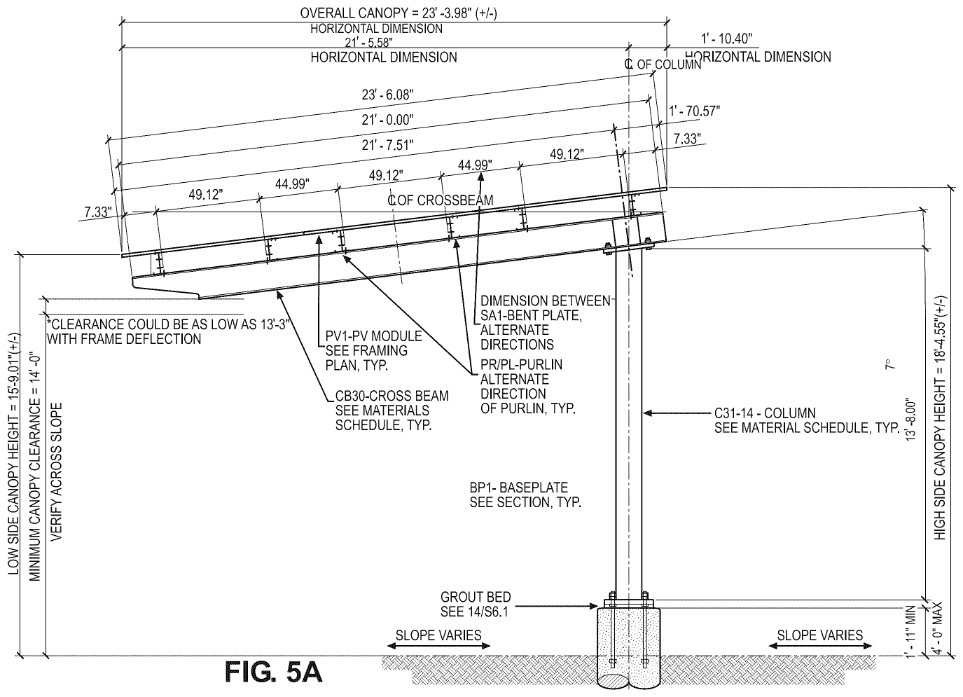

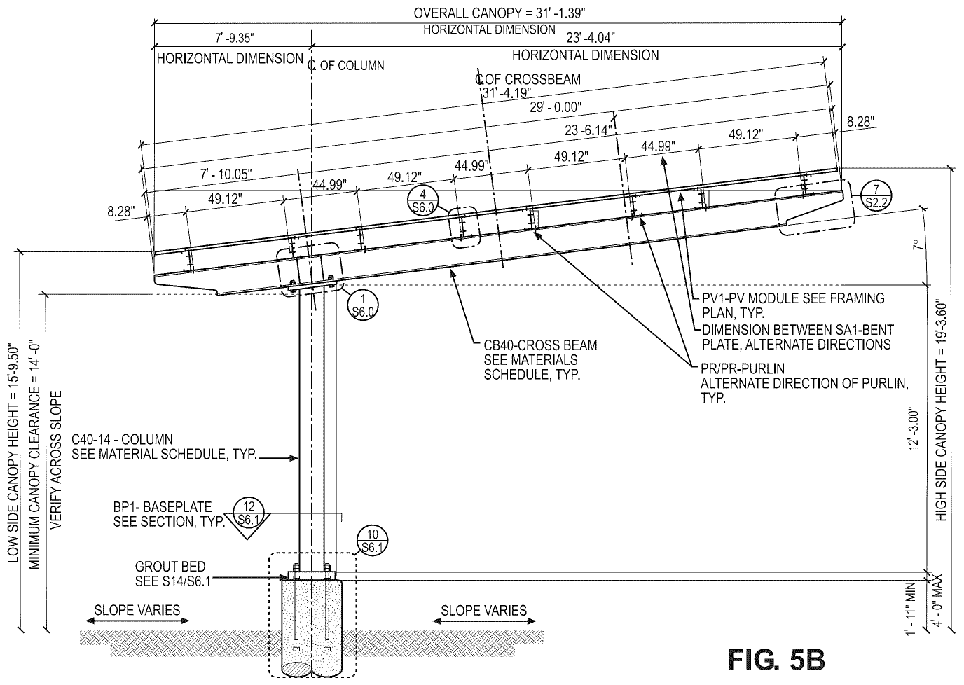

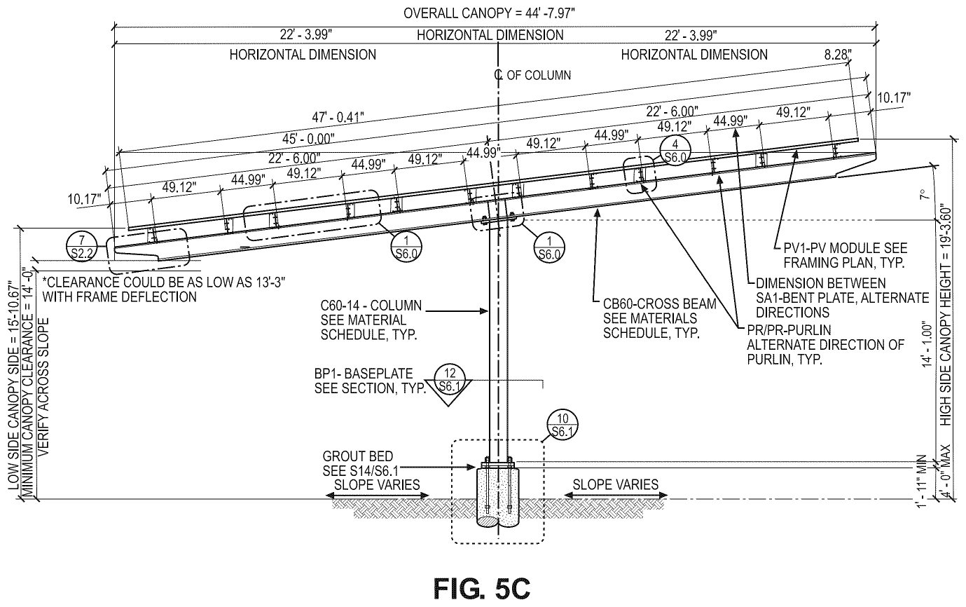

FIGS. 5A, 5B and 5C show an example of three different models of solar carports, and a sample of their construction specifications. As is readily apparent from these figures, each model has a form similar to that of the solar carport 400 shown in and described with reference to FIG. 4 in that it comprises two support structures (columns), a roof structure (cross beams and purlins) and a group of solar panels which may also be referred to as photovoltaic modules (PVMs). (Note, other views such as front elevation views and the specifications associated therewith will be omitted for the sake of brevity as they are not necessary for an understanding of the present technology.) The model shown in FIG. 5A may be referred to in the present disclosure as a 4 car/30 meaning it accommodates four (4) cars underneath its roof and has 30 solar panels; the model shown in FIG. 5B may be referred to as a 4 car/40 meaning it accommodates four (4) cars underneath its roof and has 40 solar panels; and the model shown in FIG. 5C may be referred to as an 8 car/60 meaning it accommodates eight (8) cars underneath its roof (4 on either side of the supports) and has 60 solar panels.

The solar panels used in all three models may comprise identical or different types of PVMs produced by one or more manufacturers. Thus, the models shown in FIGS. 5A-5C are different from each other in at least one of total number of solar panels, type of solar panel, area of roof structure, and relative location at which the roof structure is mounted to and supported by the support structure. Respective ones of the models may also be differentiated from each other by the way in which their roofs are tilted relative to their support structures (e.g., tilted upwardly or downwardly in a direction away from their support structures).

In each of the above-described models, EVCs may be mounted to and supported by the supports as shown in FIG. 4. In one example, the EVCs are connected to an electrical energy storage unit, e.g., batteries stored in a utility box at the site of the solar carport, and to which the inverter (not shown) is connected. Accordingly, the EVCs are powered by electricity stored in the batteries but produced using solar power created by the PVMs. The electrical energy storage unit may also be electrically connected to metered electricity at the site so that electricity generated by the PVMs can be fed to the grid to offset costs of electricity paid to the utility company that services the site. Still further, the electrical energy storage unit may be wired to an auxiliary electrical device at the site to similar advantage, namely, the solar energy produced by the PVMs reducing the cost of electricity at the site. Alternatively, the EVCs are electrically connected to the inverter directly such that solar charging of EVs can take place while the PVMs are producing electricity.

In any case, the EVCs may include means to accept payment for the electricity dispensed thereby. For example, the EVCs can include means to accept payment by credit card or digital wallet. Such means are well known per se and as such will not be described in any further detail hereinafter. Because the EVCs are powered by the solar energy produced by the array of solar panels 130 and not metered electricity from a utility company, the solar energy may be dispensed at even rates below that charged by the local utility company so as to help recoup the costs of constructing any number of solar carports 100 at the site.

However, none of the solar carports or not every solar carport must have an EVC or EVCs associated therewith. Some or all of the solar carports could be dedicated for use for delivering solar energy to parts of the real property site requiring electricity to reduce the costs of supplying those parts with electricity from the grid. Here, using a solar carport instead of installing solar panels on the roof of an existing building may be advantageous in terms of flexibility, and ease of construction and worker safety especially if the roof is difficult to access, the roof has a steep pitch, the roof is otherwise occupied by HVAC equipment, the building presents no ready space to accommodate an inverter or electric energy storage or the creation of a required electrical panel or sub-panel and associated wiring connections to the existing electrical system, etc.

Referring still to FIG. 1, the design layout may be created (S120) by overlaying respective representations of one or more of the models of the solar carports on the digital image, within the selected geographic region identified in step (S110). When there is more than one model of solar carport to choose from, the selection of the specific models to be built on site may be based at least in part on preferences of the entity commissioning the constructing of the solar power-generating installation. For example, the resulting aesthetics of the site in building solar carports of the same model adjacent to each other might be a consideration.

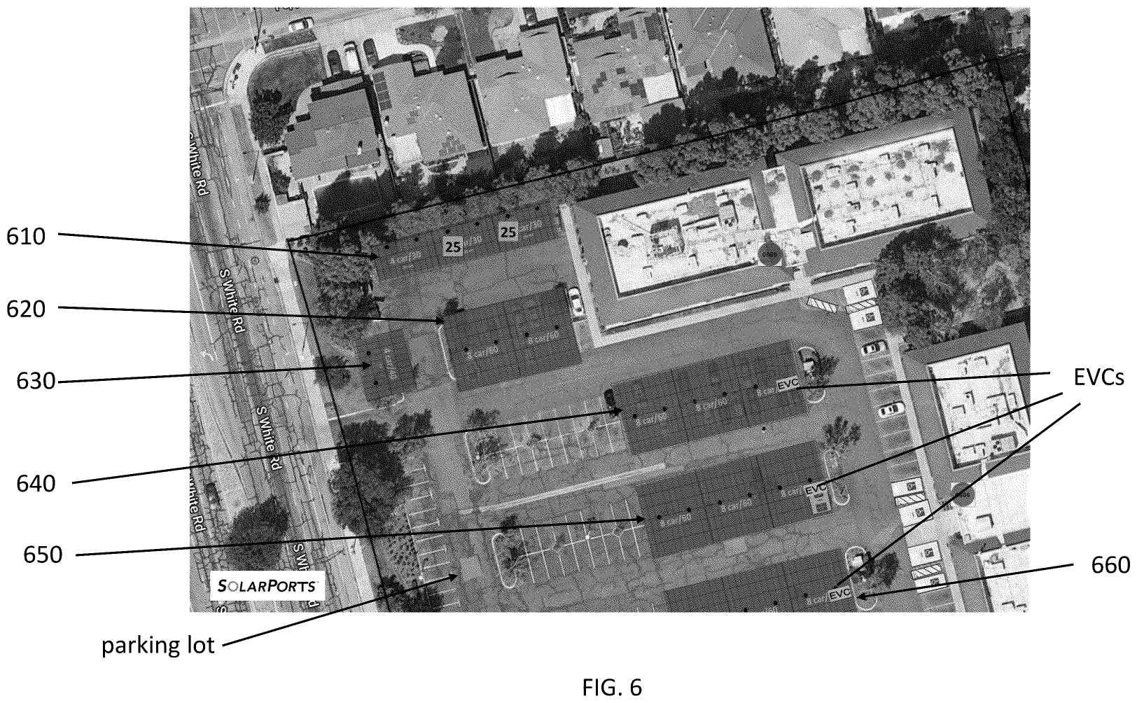

FIG. 6 shows an example of a design layout produced at step (S120) in the method of FIG. 1 using the digital overhead image of the site acquired at step (S100) and the geographic region (discrete parts) of the site identified at step (S110). As can be seen from this figure, the design layout includes representations 610 of three 4 car/30 models overlayed side-by-side on one part of the geographic region (12 parking spaces at the side of the parking lot that abuts undeveloped land), a representation 620 of one 4 car/40 model overlayed on another part of the geographic region (4 parking spaces at another side of the parking lot that abuts undeveloped land), representations 630 of two 8 car/60 models overlayed side-by-side on yet another part of the geographic region (16 parking spaces across an open interior region of the parking lot), and three (of four) representations 640, 650 and 660 each of three 8 car/60 models overlayed side-by-side on still another respective part of the geographic region (24 parking spaces across a region of the parking lot where 12 of the spaces are disposed on one side of a center island and another 12 spaces are disposed on the other side of the center island).

It will be readily appreciated from this example of a design layout of a solar power-generating installation, that selection/identification of the areas of the parking lot and the models of the solar carports whose representations are overlayed on those areas are identified/selected based in part on characteristics of parking lot and aesthetics of the design when implemented.

In addition, this particular example of a design layout has the locations of three EVCs each associated with and powered by the solar panels of three 8 car/60 models disposed side-by-side, as indicated in the representations 640, 650 and 660. The representations 610 through 660 and the locations of the EVCs may be provided as computer icons. Note, also, the type of EVC (e.g., Level 2 and/or Level 3) may also be specified in the design layout, as well as indication of whether the EVC is to be mounted to a support of the solar carport or is to be part of a stand-alone EVC structure to be constructed beneath the roof of the solar carport,

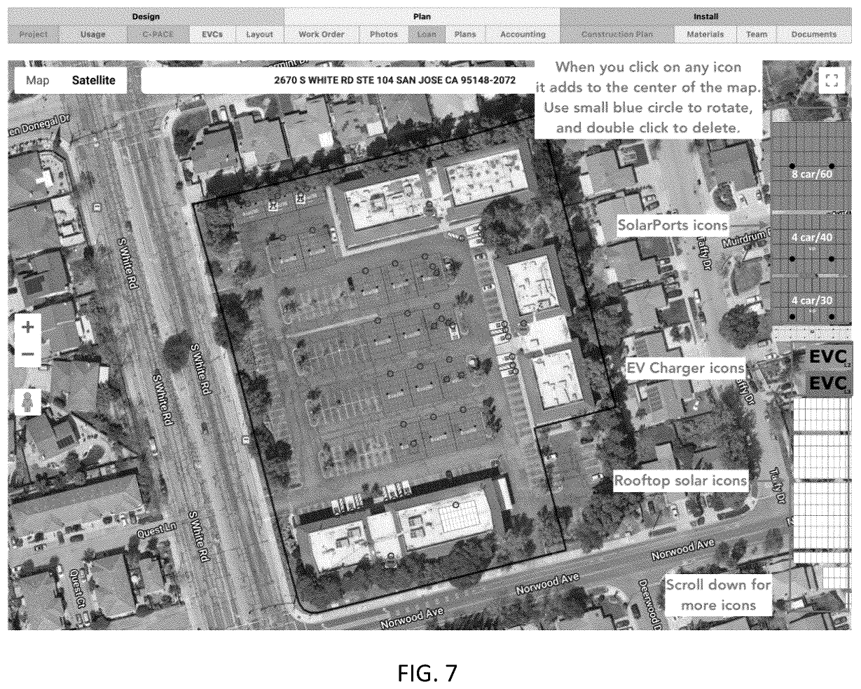

In one example of step (S120) illustrated by FIGS. 7-9, the respective representations 610-650 of the models of solar carports and the locations and types of the EVCs are overlayed on the geographic region by displaying the overhead image of the real property site on the screen of a computer (stand-alone display or display of a desktop, laptop, tablet, etc.), and dragging and dropping icons onto the displayed image (examples of such icons being shown in FIG. 7). The dragging and dropping may be facilitated by a computer system (described in more detail later on) having a user interface configured for this purpose (comprising a mouse or touch screen, for example).

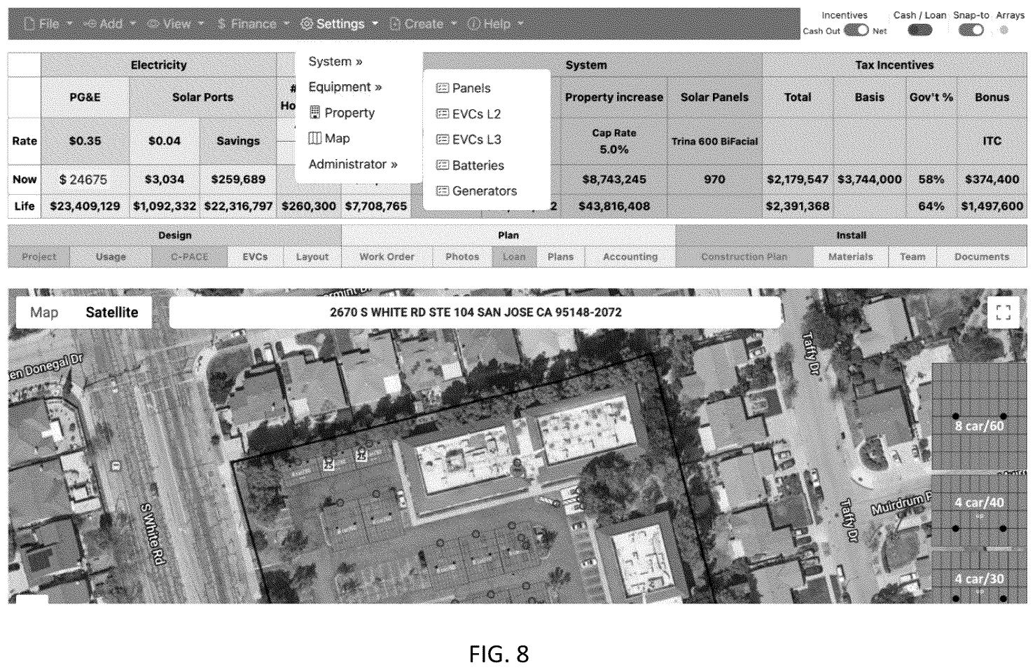

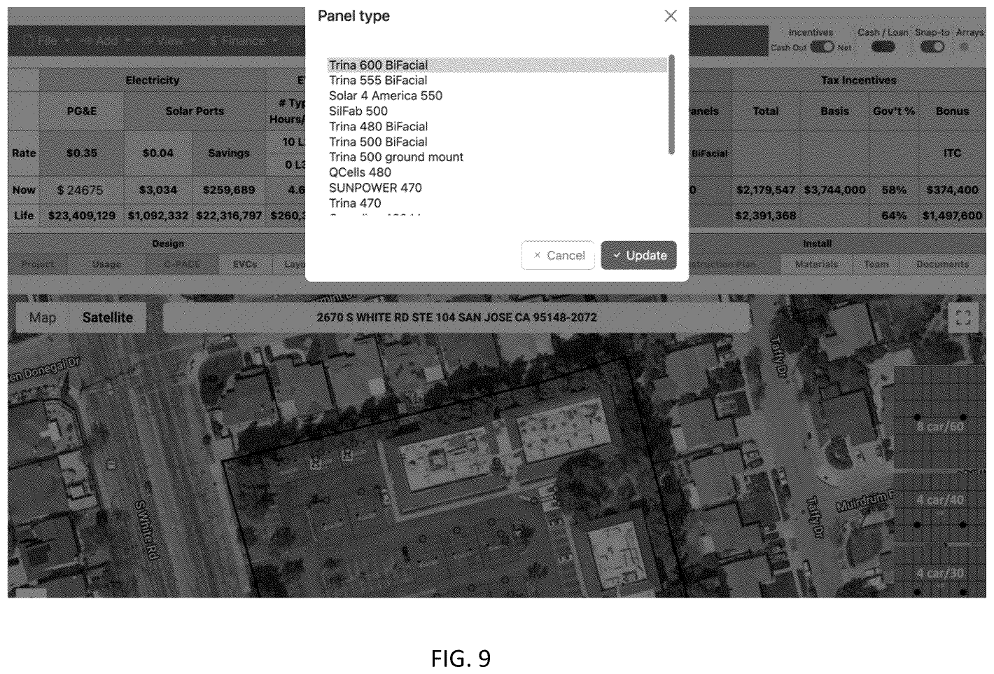

In addition, the icons themselves might not represent all of the design parameters of the solar power-generating installation. For instance, as shown in FIG. 8, a separate drop-down menu can be provided by the computer system for designating in the design layout the type of solar panels, type of EVC(s), batteries for storing electricity generated by the solar panels, etc. FIG. 9 shows a drop-down menu for selecting solar panels from among a number of different types available in the market. And so, a whole host of components are selected for any model of solar carport, including but not limited to a particular type of solar panel, and an inverter and other electrical components.

In another example of step (S130), a digital version of the geographic region is automatically populated with data representative of a plurality of the solar carports using a computer tool such as a machine learning tool trained to select the models of solar carports, EVCs, etc. fitted to the geographic region based on a number of factors including those previously described above in connection with user selection.

Next, construction specifications for the models of solar carports represented in the design layout are generated (S130). In some embodiments of the present technology the construction specifications are generated dynamically from the design layout. For instance, the construction specifications for each of the solar carports may be generated dynamically based on one or more geographical and/or physical characteristics of the location of the solar carport in the design layout. Alternatively, the construction specifications for each of the solar carports are generated dynamically based on the components selected (inputs) during the creating of the design layout in step (S120).

In other embodiments, a digital repository containing construction specifications of the one or more models of the solar carports is provided. That is, each of the solar carports in the design layout may be of a respective pre-designed and pre-engineered freestanding model whose construction specifications are contained in a digital repository. The digital repository may be stored in a memory in the same computer which acquires (and displays) the digital image of the overhead view of the real property site (S100). Alternatively, the digital repository is provided in remote storage, e.g., a server, accessed by the computer networked with the remote storage, i.e., on the cloud. The same is true for the tools/software by which step (S120) is executed.

In these cases, the digital repository is accessed and construction specifications correlated with the models of the solar carports represented in the design layout are used to generate the construction specifications (S130) for the solar power-generating installation.

And so, for any model of solar carport having a particular type of solar panel, the digital repository may include construction specifications of the roof structure including mounts for facilitating the attachment of solar panels of a particular type, and for wiring the solar panels to an inverter, etc., along with the construction specifications for the support(s), etc. Likewise, the construction specifications for EVCs (e.g., Level 2 and/or Level 3) may also be provided in the digital repository, e.g., construction specifications for mounting the EVC to a support of the solar carport and/or construction specifications of a stand-alone EVC structure to be constructed beneath the roof of the solar carport.

In still further embodiments, a combination of more than one of the above-described processes for generating the construction specifications in step (S130) are used. That is, construction specifications can be generated dynamically based upon aspects of the geographic region identified in step (S110), dynamically based on selection of components/aspects of the solar carports using various menus of the platform (examples of which are shown in FIGS. 8 and 9), and/or by accessing a digital repository of construction specifications.

Next, a set of construction plans for the solar power-generating installation, in conformance with the design layout, is automatically generated (S140). The construction plans include the construction specifications (design specs) generated in step (S130). The construction plans may include not only the construction specifications but a construction schedule and parts list as well. As mentioned above, a sample of the construction specifications (canopy plans) are shown in FIGS. 5A-5C. The construction plans may be stored in digital form or printed out for use by the builder, sub-contractors, etc.

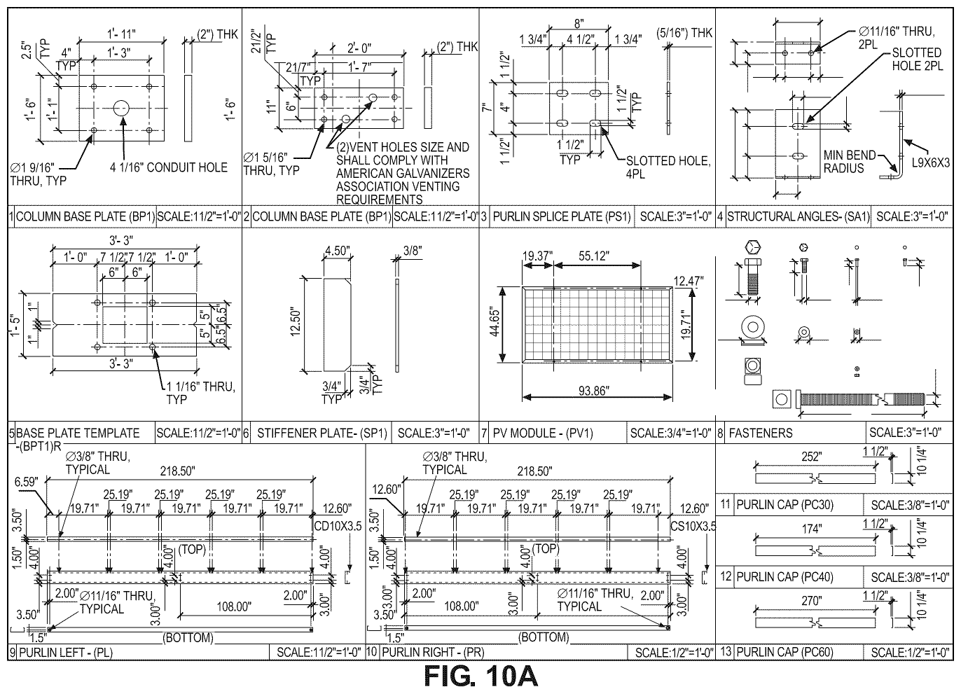

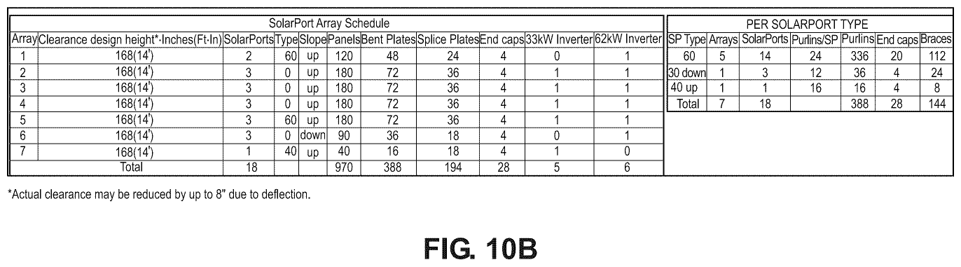

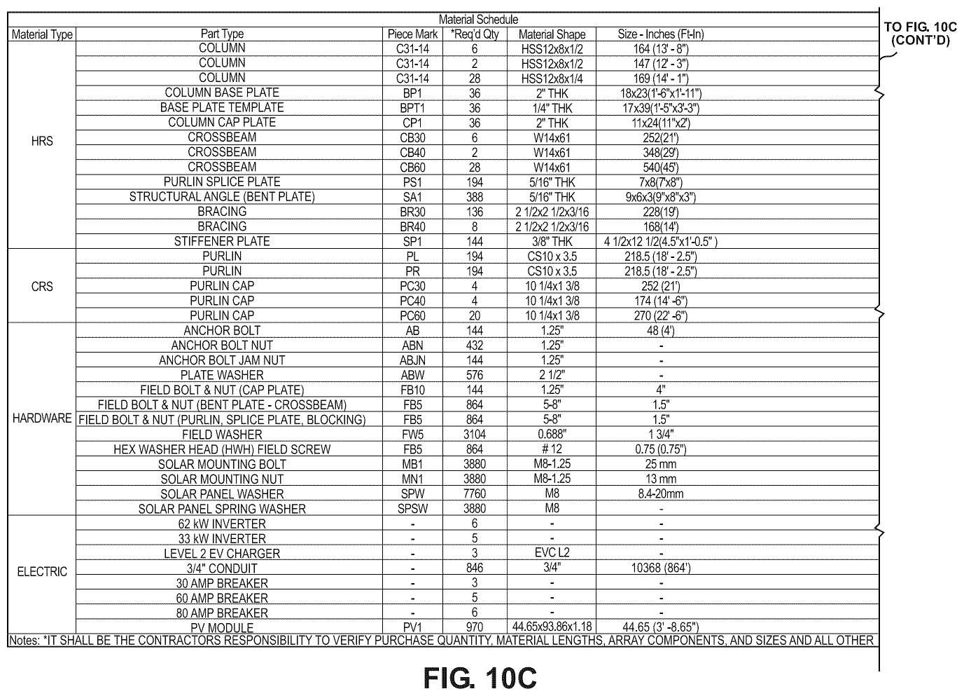

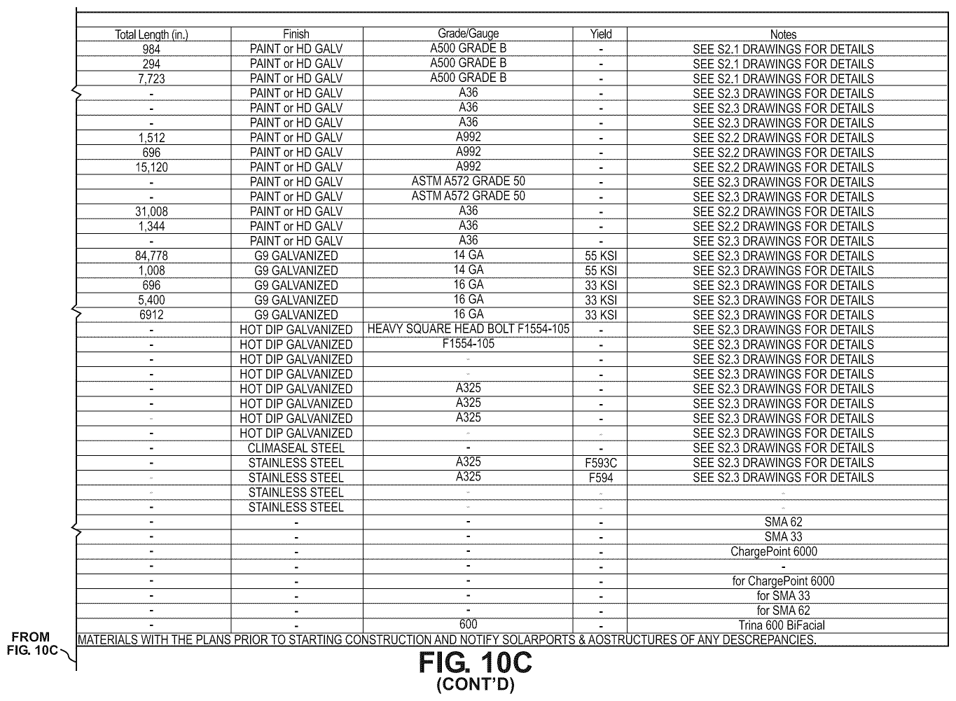

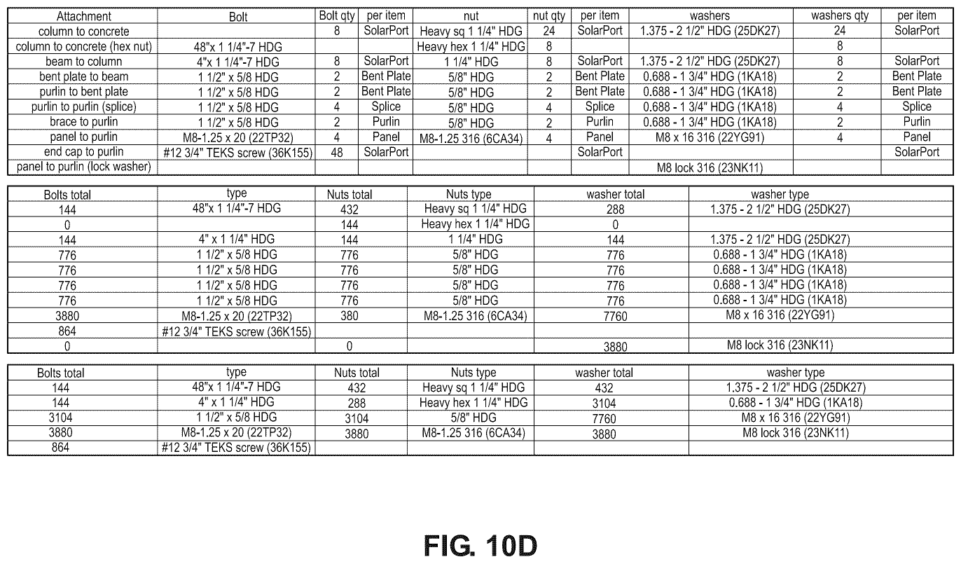

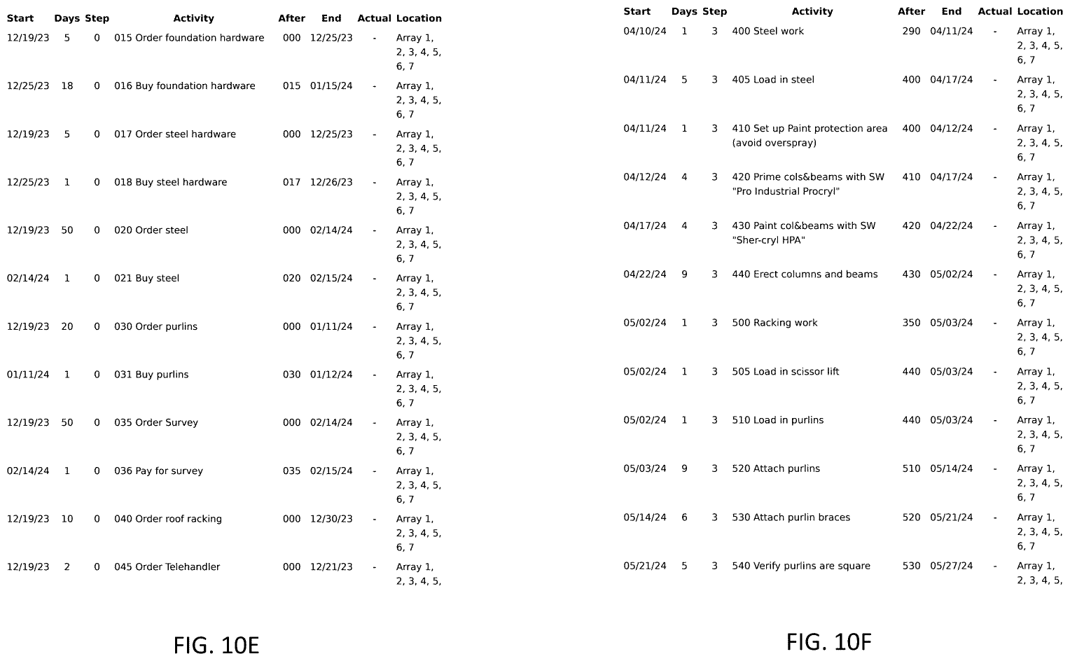

Examples of other construction specifications are those of a framing plan for the roof structure as viewed in plan, specs for steel connections between columns and purlins of the roof structure, and between beams and the purlins of the roof structure, and foundation connection details. The construction specifications may also include those for splicing the roof structures of the same model of solar carport together when the solar carports are disposed side-by-side. However, such splicing is not required and, in fact, it may be preferable to provide some space between respective ones of the solar carports disposed adjacent to each other. Basically, the design specs may include all those necessary to produce architectural plans to code for use in approval by the local building authority. FIGS. 10A-10D shows a sample set of the design specifications.

The construction schedule may include parts ordering and work schedules, with estimates for dates and activities to bring the construction to completion. A sample of parts of such a construction schedule is shown in FIGS. 10E and 10F.

Then, the solar power-generating installation is constructed according to the plans, as represented by a method shown in FIG. 1 including the “BUILD” step. As a result, a plurality of respective solar carports each including one or more supports, a roof structure mounted to and supported by the one or more supports, and solar panels mounted to the roof structure are built. Also, at least one EVC may be installed within the geographic region as each operatively connected to respective ones of the solar panels. All of this is accomplished without the need to custom design and custom build the solar carports and many, if not all, of their related fixtures.

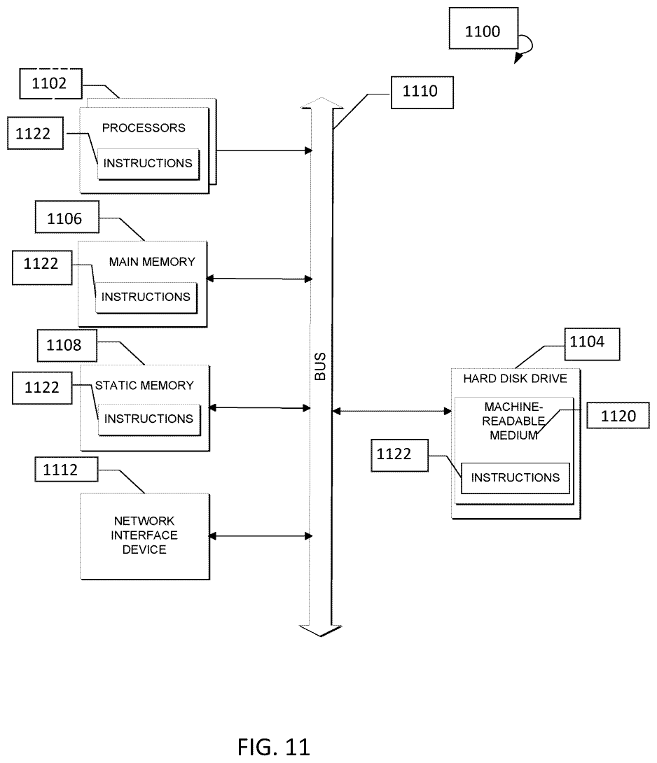

FIG. 11 is a diagrammatic representation of a computing device for a machine in the exemplary electronic form of a computer system 1100, within which a set of instructions for causing the machine to perform the above-described steps and method can be executed. In various embodiments, the machine is connected (e.g., networked) to other machines, such as a server(s) which stores the database of satellite images from which the digital image of an overhead view of the real property site is acquired (S100 in FIG. 1). In a networked deployment, the machine can operate in the capacity of a server or a client machine in a server-client network environment, or as a peer machine in a peer-to-peer (or distributed) network environment. The machine can be a desktop or laptop PC, a tablet PC, or any machine capable of executing a set of instructions (sequential or otherwise) that specify actions to be taken by that machine. Furthermore, while only a single machine is illustrated, the term “machine” shall also be taken to include any collection of devices that individually or jointly execute a set (or multiple sets) of instructions to perform any one or more of the methods and/or steps discussed herein. Thus, the machine may also include a display such as an LCD on which the image of the real property site is displayed during creation of the design layout (S130 in FIG. 1).

The example computer system 1100 includes a processor or multiple processors 1102, a hard disk drive 1104, a main memory 1106, and a static memory 1108, which communicate with each other via a bus 1110. The computer system 1100 may also include a network interface device 1112. The hard disk drive 1104 may include a non-transitory computer-readable medium 1120, which stores one or more sets of instructions 1122 for carrying out or executing any of the functions/processes described herein. The instructions 1122 can also reside, completely or at least partially, within the main memory 1106, the static memory 1108, and/or within the processors 1102 during execution thereof by the computer system 1100.

Although the non-transitory computer-readable medium 1120 is shown as a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine (such as algorithms for dynamically creating the construction specifications) and that causes the machine to perform any one or more of the steps, functions, methods of the present technology, or that is capable of storing, encoding, or carrying data structures (such as the above-described digital repository) utilized by or associated with such a set of instructions. The term “computer-readable medium” shall accordingly be taken to include, but not be limited to, solid-state memories, optical and magnetic media. Such media can also include, without limitation, hard disks, floppy disks, NAND or NOR flash memory, digital video disks (DVDs), Random Access Memory (RAM), Read-Only Memory (ROM), and the like.

The machine is also a specialized device configured to provide tools of a computer-aided design (CAD) system, known per se, to provide steps, functions, processes of the present technology as described above, including but not limited to producing drop-down menus on a display, displaying icons, facilitating a drag and drop function for placing the icons over an image displayed on a screen, calculating construction specifications from inputs, etc. Specific examples of such tools but which are customized in accordance with the present technology include Geometric Modeling Tools such as a 2D drafting tool, Editing and Modification Tools such as a selection tool that allows selection of individual entities (e.g., icons), groups of entities, or whole faces of a model for further manipulation and a transformation tool that allows a user to move, rotate, scale, and mirror entities, Annotation and Documentation Tools and Rendering and Visualization Tools. An Annotation, tool, for example, may be used to correlate the icons with the design specifications stored in the digital repository.

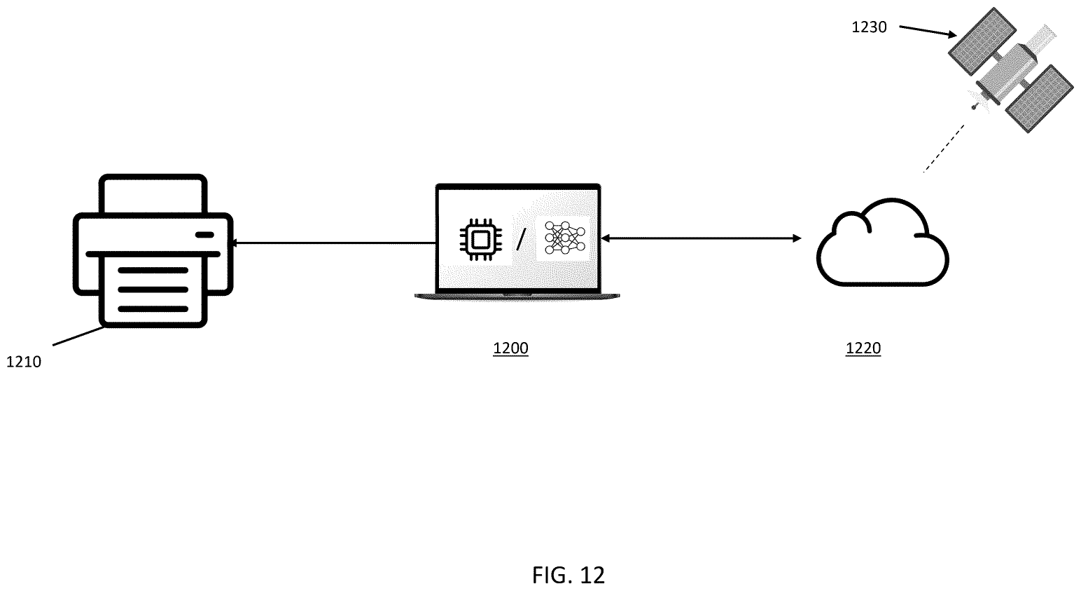

FIG. 12 schematically illustrates a networked system, including a machine, according to the present technology. In the system shown in FIG. 12, reference numeral 1200 designates a computer on which the method of FIG. 1 is executed. In this example, the overhead view of the real property site is acquired through the cloud 1220. There, servers may store satellite images of sites captured by satellite system 1230 and correlated with street addresses of the sites. The computer 1200 or cloud 1220 may provide the non-transitory computer readable medium by which the design layout is created in step (S120). Thus, the computer 1200 and cloud 1220 may constitute a network by which the present technology is implemented. In some embodiments the network comprises a CPU for use in creating the design layout (S120), generating the construction specifications (S130) and automatically generating the set of construction plans (S130) and in other embodiments the computer 1200 comprises a GPU configured with a machine learning tool (neural network) for populating the geographic region identified in step (S110) with representations of models of the solar carports and providing other inputs from which the construction specifications are generated (S130). The system may also include a printer 1210, e.g., a large format printer, on which the construction plans automatically generated in step (S140) are printed.

Finally, although the present technology has been described above in detail with respect to various embodiments and examples thereof, the technology may be embodied in many different forms to implement one or more aspects of the present invention. Thus, the present invention should not be construed as being limited to the embodiments and their examples described above. Rather, these embodiments and examples were described so that this disclosure is thorough, complete, and fully conveys the present invention to those skilled in the art. Thus, the true spirit and scope of the present invention is not limited by the description above but by the following claims.

What is claimed is:

1. A construction method comprising:
acquiring a digital image of an overhead view of a real property site;
identifying a geographic region within the boundary of the real property site as installation sites for a plurality of solar carports;
creating a design layout of one or more models of solar carports including by displaying the digital image, and overlaying respective representations of the one or more models of solar carports on portions of the digital image depicting the geographic region, each model of solar carport including one or more supports, a roof structure mounted to and supported by the one or more supports, and solar panels mounted to the roof structure;
generating construction specifications for the solar carports indicated in the design layout;
automatically generating a set of construction plans based on the construction specifications of the solar carports represented in the design layout, whereby a set of construction plans tailored to the real property site can be produced without sending personnel out to the real property site; and
constructing a solar carport installation, conforming to the design layout, on the geographic region of the real property site using the set of construction plans,
whereby the constructing comprising building a plurality of respective solar carports each including one or more supports, a roof structure mounted to and supported by the one or more supports, and solar panels mounted to the roof structure.

2. The method as claimed in claim 1, wherein the acquiring of an overhead image comprises accessing a database of satellite images of existing real property, and selecting one of the satellite images based on a street address of the real property site.

3. The method as claimed in claim 1, wherein the identifying includes identifying an area within the real property site dedicated for use as vehicle parking, and selecting part of the area as the geographic region.

4. The method as claimed in claim 1, wherein the overlaying of respective representations of the one or more models of solar carports on the geographic region comprises dragging and dropping icons of one or more of the models of solar carports on the overhead image of the real property site.

5. The method as claimed in claim 1, wherein the creating of the design layout comprises overlaying respective representations of the one or more of the models of the solar carports on the geographic region based at least in part on preferences of an entity commissioning the constructing of the solar carport installation.

6. The method as claimed in claim 1, wherein the creating of the design layout comprises overlaying respective representations of the one or more of the models of the solar carports on the geographic region based at least in part on characteristics of areas of the real estate of the geographic region where it is desired to construct the solar carports.

7. The method as claimed in claim 1, wherein the generating of construction specifications comprises generating construction specifications for a plurality of different models of the solar carports, the models being different from each other in at least one of total number of solar panels, type of solar panel, area of roof structure, and relative location at which the roof structure is mounted to and supported by the at least one support.

8. The method as claimed in claim 7, wherein at least some of the construction specifications for each of the solar carports are generated dynamically based on one or more characteristics of that portion of the geographic region where the representation of the solar carport is located.

9. The method as claimed in claim 7, comprising selecting a number of components of each of the solar carports whose representations are indicated in the design layout, and wherein at least some of the construction specifications for each of the solar carports are generated dynamically based on the components selected.

10. The method as claimed in claim 1, wherein the creating of the design layout includes laying out a representation of at least one electric vehicle charger (EVC) on the digital image each in association with a respective one of the representations of solar carports.

11. A method for use in constructing a solar carport installation at a real property site, the method comprising:
acquiring a digital image of an overhead view of a real property site;
identifying a geographic region within the boundary of the real property site as installation sites for a plurality of solar carports;
creating a design layout of one or more models of solar carports including by displaying the digital image, and overlaying respective representations of the one or more models of solar carports on portions of the digital image depicting the geographic region, each model of solar carport including one or more supports, a roof structure mounted to and supported by the one or more supports, and solar panels mounted to the roof structure;
generating construction specifications for the solar carports indicated in the design layout; and
automatically generating a set of construction plans based on the construction specifications of the solar carports represented in the design layout, whereby a set of construction plans for a solar carport installation tailored to the real property site set can be produced without sending personnel out to the real property site.

12. The method as claimed in claim 11, wherein the acquiring of the digital image comprises accessing a database of satellite images of existing real property, and selecting one of the satellite images based on a street address of the real property site.

13. The method as claimed in claim 11, wherein the identifying includes identifying an area within the real property site dedicated for use as vehicle parking, and selecting part of the area as the geographic region.

14. The method as claimed in claim 11, wherein the overlaying of respective representations of the one or more models of solar carports on the geographic region comprises dragging and dropping icons of one or more of the models of solar carports on the overhead image of the real property site.

15. The method as claimed in claim 11, wherein the creating of the design layout comprises overlaying respective representations of the one or more of the models of the solar carports on the geographic region based at least in part on characteristics of areas of the real estate of the geographic region where it is desired to construct the solar carports.

16. The method as claimed in claim 11, wherein the generating of construction specifications comprises generating construction specifications for a plurality of different models of the solar carports, the models being different from each other in at least one of total number of solar panels, type of solar panel, area of roof structure, and relative location at which the roof structure is mounted to and supported by the one or more supports.

17. The method as claimed in claim 16, wherein at least some of the construction specifications for each of the solar carports are generated dynamically based on one or more characteristics of that portion of the geographic region where the representation of the solar carport is located.

18. The method as claimed in claim 16, comprising selecting a number of components of each of the solar carports whose representations are indicated in the design layout, and wherein at least some of the construction specifications for each of the solar carports are generated dynamically based on the components selected.

19. The method as claimed in claim 11, wherein the creating of the design layout comprises specifying a location of at least one electric vehicle charger (EVC) within geographic region as each associated with a respective one of the solar carports.

20. A device, comprising:
a processor; and
a non-transitory computer readable medium storing instructions executable by the processor to:
acquire a digital image of an overhead view of a real property site;
display the digital image;
provide a tool by which representations of one or more models of solar carports can be overlayed on the displayed digital image to create a design layout of solar carports;
generate construction specifications for the solar carports indicated in the design layout; and
automatically generate a set of construction plans based on the construction specifications of the solar carports represented in the design layout, whereby a set of construction plans for a solar carport installation tailored to the real property site set can be produced without sending personnel out to the real property site.
